(19) United States
(12) Patent Application Publication
(10) Pub. No.: US 2005/0099031 A1
(43) Pub. Date: May 12, 2005

(54) Studying chopstick for developing children's intellectual powers

(76) Inventor: Byoung Jin Park, Bucheon-city (KR)

Correspondence Address: PARK & SUTTON LLP, 3255 WILSHIRE BLVD, SUITE 1110, LOS ANGELES, CA, 90010, US

(21) Appl. No.: 10/477,827

(22) PCT Filed: Aug. 13, 2002
(86) PCT No.: PCT/KR02/01541

(30) Foreign Application Priority Data
Aug. 14, 2001 (KR) 2001/49096

(51) Int. Cl. B25B 7/00; B25B 9/00

(52) U.S. Cl. 294/99.2

(57) ABSTRACT

A pair of training chopsticks for developing intellectual faculties is described. The training chopsticks comprise a first stick, a second stick and a coupling means. The first stick has a thumb-inserting hole for inserting the thumb and a first pad for picking up solids. The thumb-inserting hole is formed on the upper side of the first stick and the first pad is formed on the lower end of the first stick. The second stick has a holding unit for inserting the forefinger and the second finger, an adjusting means for adjusting the fixing position of the holding unit and a second pad for picking up solids. The holding unit has a forefinger-inserting hole for inserting the forefinger and a second finger-inserting hole for inserting the second finger. The coupling means formed on the upper sides of the first and second stick couples the first and second stick at an interval.

### BACKGROUND OF THE INVENTION

(1) Field of the Invention

The present invention relates to chopsticks for developing intellectual faculties, more particularly to a pair of training chopsticks having a removable coupling member formed between the upper sides of the first and the second stick, a thumb-inserting hole formed on the first stick, a forefinger and second finger-inserting hole formed on the second stick, and removable pads for picking up solids formed on the lower sides of the first and the second stick. The training chopsticks are of good use to novice or child users who make poor use of chopsticks.

(2) Description of the Related Arts

Chopsticks, widely used throughout Asia as an eating utensil, are effective in exercising the joints of fingers or wrists. Moreover, chopsticks are known to be effective in developing children's intelligence, specially, during their growth period, since the moving of fingers can arouse their brains.

However, chopsticks can be difficult and frustrating to use for novice users suffering from a disability, and are rarely used by children.

A number of inventions have been developed to assist the use of chopsticks. The Japanese Patent specification of No. 10-137101 describes a pair of training chopsticks on which rings for inserting fingers are formed. Referring to FIG. 1, the rings 11, 12, 21, 22 are formed on the chopsticks 10, 20, and inclined to insert fingers suitably. Marks for indicating the finger to be inserted into each ring are recorded on the rings, and arrows are marked on each top of the chopsticks in order to indicate the direction for grasping.

However, since the rings 21, 22 are fixed on the chopsticks, the chopsticks should be made in various form according to the size of the fingers. Further, it is difficult to insert fingers into the rings, since the inserting angle for the rings is steep.

Korea utility model No. 2001-23369 describes more improved training chopsticks. Referring FIG. 2, the upper sides of the chopsticks 50a, 50b are connected to each other by a connecting pin 51 including the hinge 51′. A grasp hole for the thumb 51 is formed on the chopstick 50a, and a grasp hole for the forefinger 52 and a grasp hole for the second finger 53 are formed on the other chopstick 50b. The grasp holes 51, 52, 53 are inclined to the chopsticks to fit the inserting angle of the fingers. A grasping unit 55 has the grasp hole for the forefinger 52 and the grasp hole for the second finger 53 which are formed in a body. A male screw 55b is formed on the outside of the chopstick 50b and a female screw 55a is formed on the inside of the grasping unit 55, so that the fixing position of the grasping unit 55 can be adjusted to fit the finger size of users.

Even though above described training chopsticks are some help to novice or child users, but it take much time to train the use of chopsticks. Further, above described chopsticks don't arouse children interest in the use of chopsticks.

The present invention has been developed to solve the problems with above-described chopsticks.

### SUMMARY OF THE INVENTION

It is an object of the present invention to provide a pair of training chopsticks for giving novice or child users training how to use chopsticks easily.

It is another object of the present invention to provide a pair of training chopsticks for learning how to use chopsticks step by step.

According to one aspect of the present invention there is provided a pair of training chopsticks for developing intellectual faculties. The training chopsticks comprise a first stick, a second stick and a coupling means.

The first stick has a thumb-inserting hole for inserting the thumb and a first pad for picking up solids. The thumb-inserting hole is formed on the upper side of the first stick and the first pad is formed on the lower end of the first stick.

The second stick has a holding unit for inserting the forefinger and the second finger, an adjusting means for adjusting the fixing position of the holding unit and a second pad for picking up solids. The holding unit has a forefinger-inserting hole for inserting the forefinger and a second finger-inserting hole for inserting the second finger. The second pad is formed on the lower end of the second stick.

The coupling means formed on the upper sides of the first and second stick couples the first and second stick at an interval.

The adjusting means has a male screw formed on the second stick, and the holding unit has a female screw formed on the inside thereof to engage with the male screw.

Alternatively, the adjusting means has a rubber packing elastically adhered on the fixed grooves to support the holding unit and a protrusion part formed on the inside of the holding unit. In this case, the second stick has a plurality of fixed grooves at an equal interval, and the protrusion part is engaged with the fixed grooves to adjust the fixed position of the holding unit.

The coupling means comprises a male connector formed on the upper side of the first stick and a female connector formed on the upper side of the second stick. The female connector is engaged with the male connector to sustain the first and second sticks at an interval and is capable of turning left and right on the axis of rotation.

According to another aspect of the present invention there is provided a pair of training chopsticks for developing intellectual faculties.

The training chopsticks comprise a first stick, a second stick, a coupling means, and a luminous means.

The first stick has a thumb-inserting hole for inserting the thumb, a first pad for picking up solids and an ornament of a character form. The thumb-inserting hole is formed on the upper side of the first stick, the first pad is formed on the lower end of the first stick and the ornament is formed on the upper end of the first stick.

The second stick has a holding unit for inserting the forefinger and the second finger, an adjusting means for adjusting the coupling position of the holding unit and a second pad for picking up solids. The holding unit has a forefinger-inserting hole for inserting the forefinger and a second finger-inserting hole for inserting the second finger. The second pad is formed on the lower end of the second stick.

The coupling means couples with the upper sides of the first and the second stick at an interval.

The luminous means emits light through the ornament. The luminous means is formed in the ornament and controlled by the pressure between the first and the second pad.

The luminous means comprises a mounting hole formed through the upper side of the first stick, a luminous lamp formed on the upper end of the mounting hole, a pressure hole formed on the first pad, a power supply for providing the luminous lamp with electrical power, and a pressure sensor for sensing through the pressure hole and for controlling the operation of the power supply.

The power supply comprise a male connector formed on the lower side of the first stick, a female connector for connecting with the male connector and extended to the pressure sensor, a battery unit extended to the female connector, and a power supplying line for connecting the male connector with the luminous lamp.

The coupling means comprises a male connecting ball formed on the upper side of the first stick and a female connecting hole formed on the upper side of the second stick. The female connecting hole is engaged with the male connecting ball to sustain the first and second sticks at an interval, capable of rotating in a 360-degree, and removable from the male connecting ball.

### BRIEF DESCRIPTION OF THE DRAWINGS

FIG. 1 is a schematic view showing the chopsticks according to the prior art.

FIG. 2 is a perspective view showing another chopsticks according to the prior art.

FIG. 3 is an illustrated perspective view showing the training chopsticks according to an embodiment of the present invention.

FIG. 4 is a detailed view showing a part of the training chopsticks according to an embodiment of the present invention.

FIG. 5a to 5d are detailed views showing the adjusting means of the training chopsticks according to an embodiment of the present invention.

FIG. 6 is a perspective view showing the training chopstick according to another embodiment of the present invention

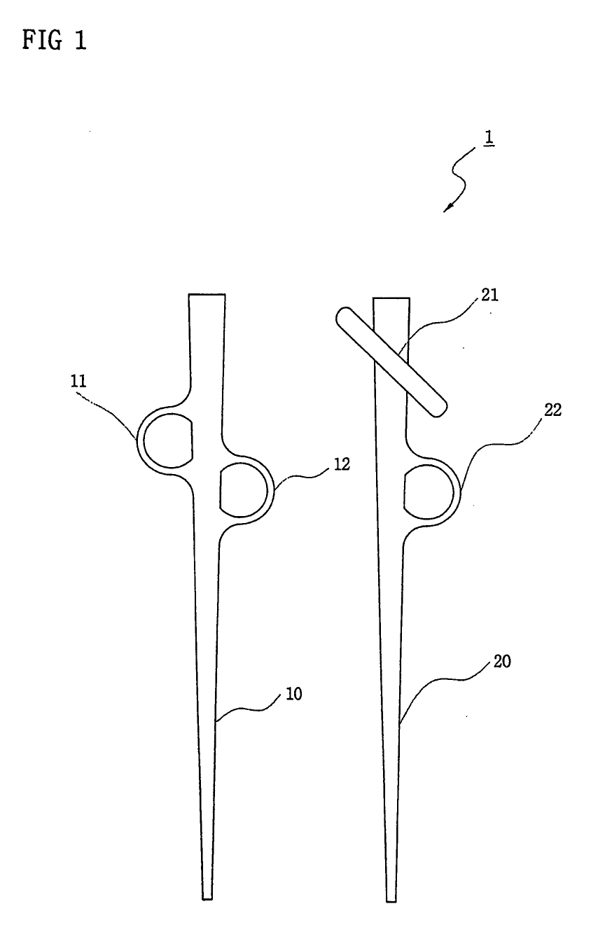

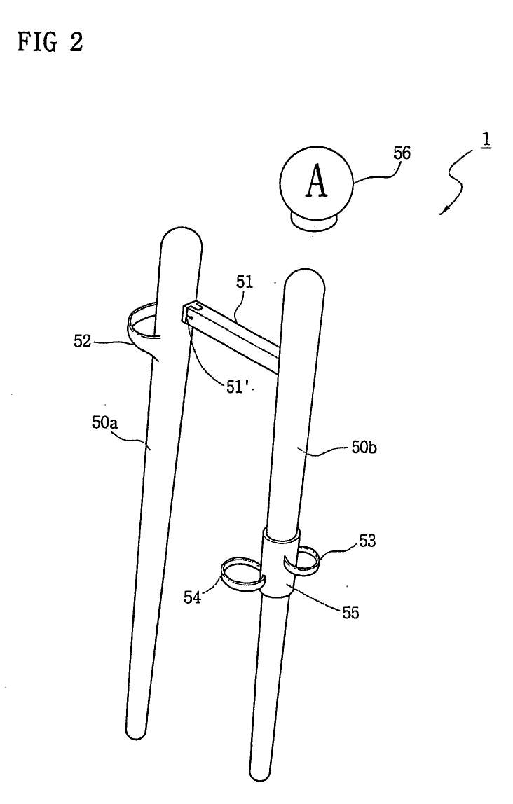

### DETAILED DESCRIPTION OF THE EMBODIMENTS

Referring now to attaching the drawings, the training chopsticks according to an embodiment of the present invention will be described in detail. It is noted that like parts are designated by like reference numerals throughout the accompanying drawings.

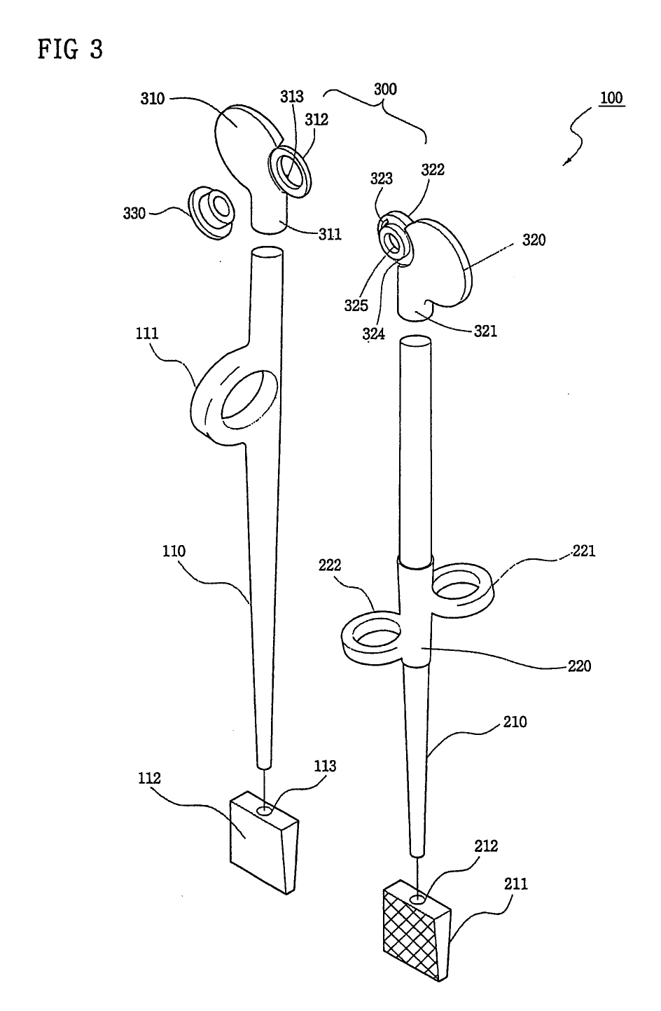

Referring to FIG. 3, the training chopsticks 100 according to the present invention comprise a pair of sticks 110, 130 which are coupled each other by a coupling means 400.

The first stick 110 has a thumb-inserting hole 111 for inserting the thumb and a first pad 200 for picking up solids such as food. The thumb-inserting hole 111 is formed on the upper side of the first stick 110, and the first pad 200 is formed on the lower end of the first stick 110.

The second stick 130 has a holding unit 120 for inserting the forefinger and the second finger, an adjusting means 300 for adjusting the coupling position of the holding unit 120 and a second pad 210 for picking up solids. The holding unit 120 is formed on the middle side of the second stick 130, and the second pad 210 is formed on the lower end of the second stick 130.

The coupling means 140 is arranged on the upper sides of the first stick 110 and the second stick 130 so that the sticks 110, 130 are supported each other at an interval.

In detail, the thumb-inserting hole 111 is formed at an angle of 10˜35 degrees with the first stick 110 so that the thumb is smoothly inserted.

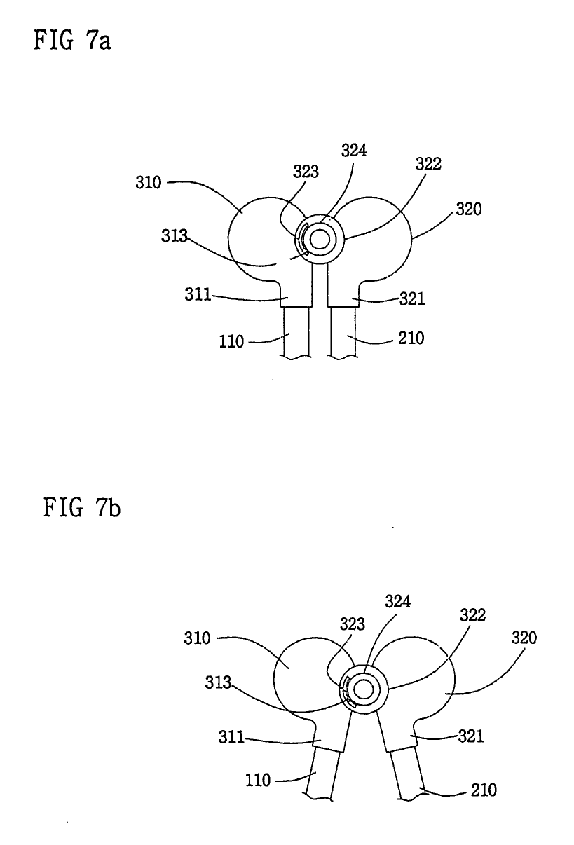

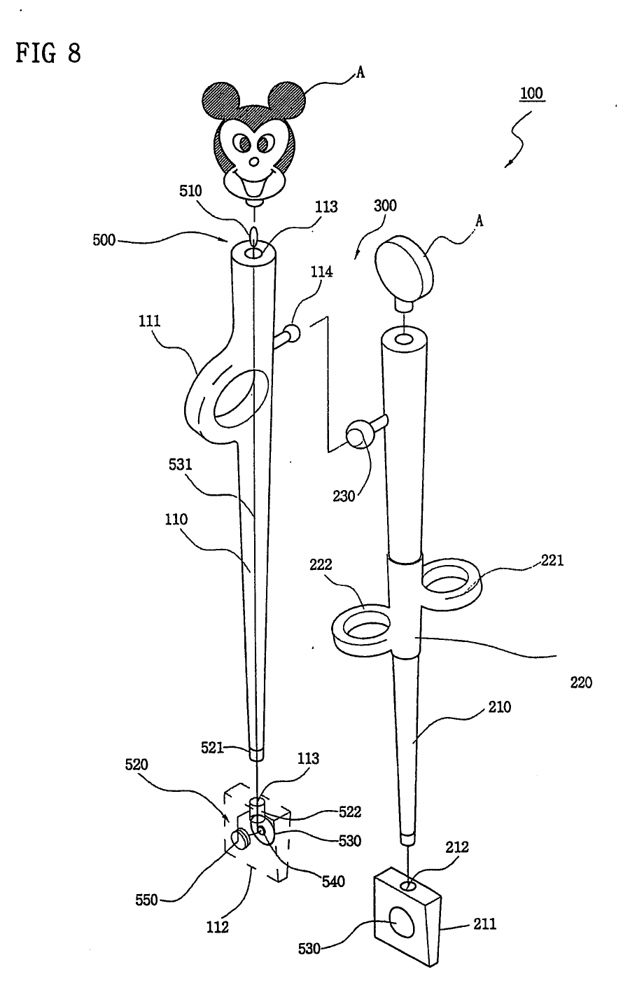

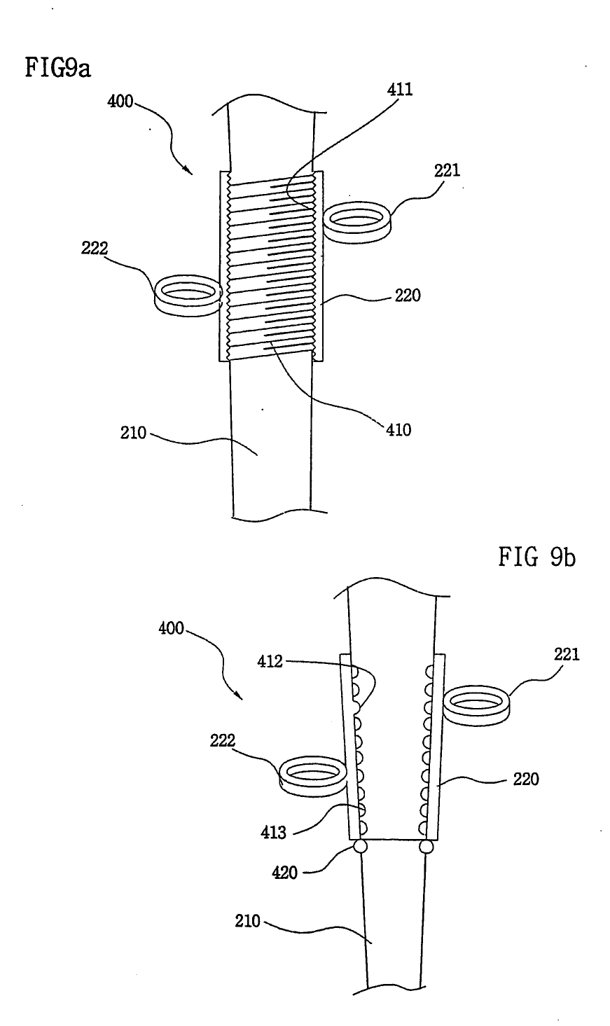

As shown FIG. 5a, the holding unit 120 has a forefinger-inserting hole 121 and a second finger-inserting hole 122 which are formed in a body.

To control the position of the holding unit 120, a female screw part 123 is formed on the inside of the holding unit 120 and a male screw part 131 is formed on the middle side of the second stick 130. To engage the screw parts 123, 131 move up and down the holding unit 120, so that the position of the holding unit 120 is adjusted.

Alternatively, as shown FIG. 5b, the position of the holding unit 120 may be adjusted by a plurality of fixed grooves 133 and a rubber packing 310. The fixed grooves 133 are formed on the middle side of the second stick 130 at an equal interval, and the rubber packing 310 is elastically adhered on the fixed groove 133 to support the holding unit 120. In such a case, the holding unit 120 has a protrusion part 124 therein to engage elastically on the fixed grooves 133.

Therefore, it can be adjusted the holding unit 120 according to the size of hands. In case of small hands, the holding unit 120 is moved up so that the space between the thumb-inserting hole 111 and the forefinger-inserting hole 121 gets narrow. On the contrary, in case of large hands, the holding unit 120 is moved down so that the space gets wide. In FIG. 5a, the holding unit 120 is moved with rotating. On the other hand, in FIG. 5b, the holding unit 120 is moved to the desired position and then fixed by coupling the elastic rubber packing 310 to the fixed grooves 133.

As above described, the position of holding unit 120 on the second stick 130 can be adjusted according to the size of user's hands, everyone may use easily the training chopsticks.

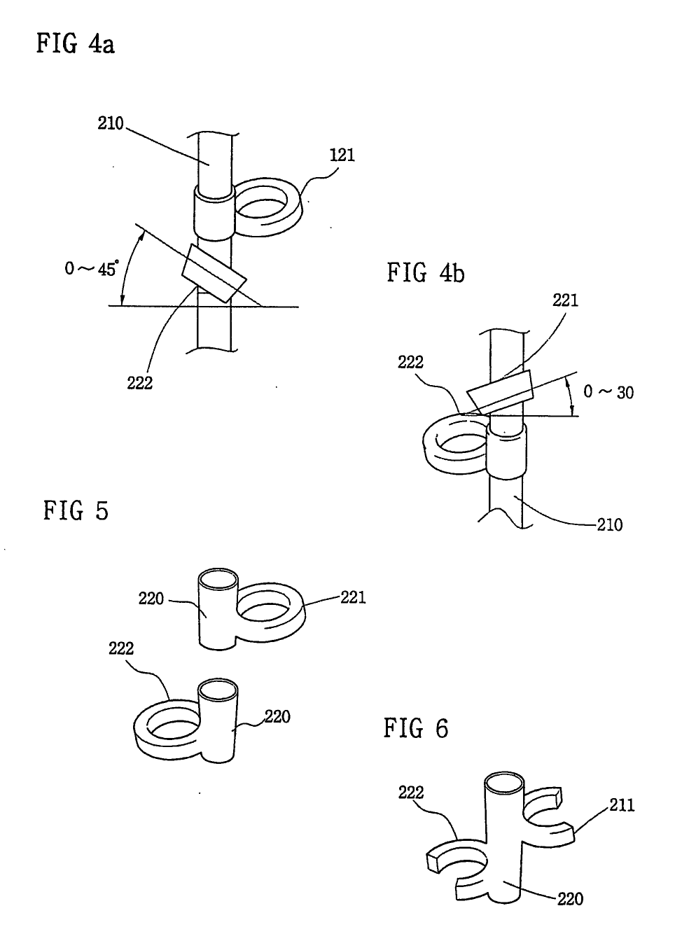

Preferably, the inserting hole 121 and 122 are made of elastic materials. Moreover, as shown FIG. 4, a male connecting ball 112 is formed in the inserting hole 111 and a female connecting hole 114 is formed in the second stick 130. Therefore, the male connecting ball 112 can rotate freely in the female connecting hole 114 so that user' finger may be inserted smoothly into the inserting hole 111.

Further, each inside surface of the first and the second pad 200, 210 is embossed for users to pick up solids easily. Each of pads 200, 210 has a coupling hole 201 for coupling with the sticks 110, 130. Therefore, after users are practiced in manipulating chopsticks, the pads may be removed.

To supporting the sticks 110, 130 at an interval, a coupling means 400 is arranged in the upper sides of the first and the second stick 110, 130. As shown FIG. 3, the coupling means 400 comprises a male connecter 410 and a female connector 420 for sustaining the distance between the sticks at an interval. The female connector 420 engages with the male connector 410 and turns left and right on the axis of rotation 411.

Each of the first and second stick 110, 130, as shown FIG. 4, has mounting grooves 415, and the coupling means 400 has mounting members 412 for connecting with the mounting grooves 415. Each of the mounting grooves has screw holes 414 and each of the mounting members 412 has screw holes 413. By screwing through the screws 413, 414, each end of the mounting members 412 is connected with the mounting grooves 415.

An ornament(A) as products featuring popular characters is inserted into the mounting hole 113 formed on the upper ends of the first and second sticks 110, 130, so that child users have interest in using the chopsticks.

In the using the training chopsticks according to the present invention, the thumb is inserted into the thumb-inserting hole 110 of the first stick 110 and each of the forefinger and the second finger is inserted into the forefinger-inserting hole 121 and the second finger-inserting hole 122 which are formed on the holding unit 120.

As described above, since the first and second sticks 110, 130 are connected each other, novice or child users easily pick up solids with the chopsticks 100.

After being practiced in manipulating chopsticks, the users are able to use the chopsticks 100 without the pads 200, 210, and moreover, without the coupling means 400.

That is, according to the ability of manipulating chopsticks, the pads 200, 210 may be removed from the first and second sticks 110, 120, and the mounting members 412 may be removed from the chopsticks 100.

In the first level, that is, the first time that users make use of the chopsticks, the hinge of FIG. 3 capable of moving only up and down is used. In the second level, the hinge is replaced with the hinge of FIG. 6 whose female connector and male connector are capable of rotating each other. In the third level, the hinge and the chopsticks are separated, and in the forth level, the holding unit 120 is removed.

With training the usage of chopsticks as above described, novice or child users learn how to use chopsticks step by step.

Another embodiment of training chopsticks 100 of the present invention is shown in FIG. 6.

A first stick 110 has a thumb-inserting hole 111 for inserting the thumb, a first pad 200 for picking up solids and an ornament A of a character form. The thumb-inserting hole 111 is formed on the upper side of the first stick 110, the first pad 200 is formed on the lower end of the first stick 110 and the ornament A is formed on the upper end of the first stick.

A second stick 130 has a holding unit 120 for inserting the forefinger and the second finger, an adjusting means 300 for adjusting the coupling position of the holding unit 120 and a second pad 210 for picking up solids. The holding unit 120 has a forefinger-inserting hole 121 for inserting the forefinger and a second finger-inserting hole 122 for inserting the second finger.

A coupling means 400 is formed on the upper side of the first stick 110 and the second stick 130 to maintain fixedly the distance between the sticks.

A luminous means 500 for emitting light is formed in the ornament A and controlled by the pressure between the first pad 200 and the second pad 210.

The luminous means 500 has a mounting hole 113 formed through the upper side of the first stick 110, a luminous lamp 510 formed on the upper end of the mounting hole 113, a pressure hole 202 formed on the first pad 200, a power supply 520 for providing the luminous lamp 510 with electrical power, a pressure sensor 230 for sensing through the pressure hole 202 and for controlling the operation of the power supply 520.

The power supply 520 has a male connector 521 formed on the lower side of the first stick 110, and a female connector 522 for connecting with the male connector 521 and extended to the pressure sensor 230, a battery unit 530 extended to the female connector 522, and a power supplying line 531 for connecting the male connector 521 with the luminous lamp 510.

The coupling means 400 comprises a male connecting ball 410 formed on the upper side of the first stick 110 and a female connecting hole 420 are formed on the upper side of the second stick 130. The female connecting hole 420 is engaged with the male connecting ball 410 to sustain the first and second sticks 110, 130 at an interval. The female connecting hole 420 is capable of rotating in a 360-degree, and removable from the male connecting ball 410.

In using the training chopsticks, novice or child users insert his thumb, forefinger and second finger into the thumb-inserting hole 111, the forefinger-inserting hole 121 and a second finger-inserting hole 122, respectively. Next, when the users grasp his fingers to pick up solids, a grasping pressure is applied to the pressure hole 202 and the pressure sensor 230 senses the pressure so that the luminous lamp 510 is lit by the electrical power of the battery unit 530. If the grasping pressure is weak, the light of the luminous lamp 510 is dimmed or failed. Therefore, the users should grasp firmly the training chopsticks 100.

After becoming skillful to some extend, the users make use of the training chopsticks without the pads 200, 210. That is, the training chopsticks are used with removing the pads 200, 210 from the first and second stick 110, 130. In case of becoming more skillful, the uses make use of the training chopsticks with removing the coupling means 400.

The present invention has the effects as follows.

First, the training chopsticks aids novice or child users to use easily chopsticks and is used as an appliance for rehabilitating.

Second, since the ornament of the training chopsticks emits light, child users take interest in the use of chopsticks and it is easy for an instructor in rehabilitation to check how to use the training chopsticks properly.

Third, the training chopsticks are used as a game for developing intelligence, for example, the pickup of bead, the pickup of food models, the moving of solids and so on.

Fourth, the repeated using of the training chopsticks provides good exercise for the fingers of users and arouses the brains of users to develop their intelligence.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A pair of training chopsticks for developing intellectual faculties, which comprises:
a first stick having a thumb-inserting hole for inserting the thumb, and a first pad for picking up solids, wherein the thumb-inserting hole is formed on the upper side of the first stick and the first pad is formed on the lower end of the first stick;
a second stick having a holding unit for inserting the forefinger and the second finger, an adjusting means for adjusting the fixing position of the holding unit and a second pad for picking up solids, wherein the holding unit has a forefinger-inserting hole for inserting the forefinger and a second finger-inserting hole for inserting the second finger, and the second pad is formed on the lower end of the second stick; and
a coupling means for coupling the first and second stick at an interval, which is formed on the upper sides of the first and second stick.

2. A pair of training chopsticks according to claim 1, wherein the adjusting means has a male screw formed on the second stick, and
the holding unit has a female screw formed on the inside thereof to engage with the male screw.

3. A pair of training chopsticks according to claim 1, wherein the second stick has a plurality of fixed grooves at an equal interval, and
the adjusting means has a rubber packing elastically adhered on the fixed grooves to support the holding unit and a protrusion part formed on the inside of the holding unit, and the protrusion part is engaged with the fixed grooves to adjust the fixed position of the holding unit.

4. A pair of training chopsticks according to claim 1, wherein the coupling means comprises a male connector formed on the upper side of the first stick and a female connector formed on the upper side of the second stick, and the female connector is engaged with the male connector to sustain the first and second sticks at an interval and capable of turning left and right on the axis of rotation.

5. A pair of training chopsticks for developing intellectual faculties, which comprises:
a first stick having a thumb-inserting hole for inserting the thumb, a first pad for picking up solids and an ornament of a character form, wherein the thumb-inserting hole is formed on the upper side of the first stick, the first pad is formed on the lower end of the first stick and the ornament is formed on the upper end of the first stick;
a second stick having a holding unit for inserting the forefinger and the second finger, an adjusting means for adjusting the coupling position of the holding unit and a second pad for picking up solids, wherein the holding unit has a forefinger-inserting hole for inserting the forefinger and a second finger-inserting hole for inserting the second finger, and the second pad is formed on the lower end of the second stick;
a coupling means for coupling the first and second stick at an interval, which is formed on the upper sides of the first and second stick; and
a luminous means for emitting light through the ornament, wherein the luminous means is formed in the ornament and controlled by the pressure between the first and the second pad.

6. A pair of training chopsticks according to claim 5, wherein
the luminous means comprising:
a mounting hole formed through the upper side of the first stick;
a luminous lamp formed on the upper end of the mounting hole;
a pressure hole formed on the first pad;
a power supply for providing the luminous lamp with electrical power; and
a pressure sensor for sensing through the pressure hole and for controlling the operation of the power supply.

7. A pair of training chopsticks according to claim 6, wherein the power supply comprising:
a male connector formed on the lower side of the first stick;
a female connector for connecting with the male connector and extended to the pressure sensor;
a battery unit extended to the female connector; and
a power supplying line for connecting the male connector with the luminous lamp.

8. A pair of training chopsticks according to claim 5, wherein the coupling means comprises a male connecting ball formed on the upper side of the first stick and a female connecting hole formed on the upper side of the second stick, and the female connecting hole is engaged with the male connecting ball to sustain the first and second sticks at an interval, capable of rotating in a 360-degree, and removable from the male connecting ball.
